(19) United States
(12) Patent Application Publication
(10) Pub. No.: US 2013/0129305 A1
(43) Pub. Date: May 23, 2013

(54) DIGITIZED HOSPITAL MANAGEMENT SYSTEM

(71) Applicant: Fu-Wen Hsiao, Kaohsiung (TW)

(72) Inventor: Fu-Wen Hsiao, Kaohsiung (TW)

(21) Appl. No.: 13/527,360

(22) Filed: Jun. 19, 2012

(30) Foreign Application Priority Data
Nov. 22, 2011 (TW) 100142663

(51) Int. Cl. H04N 5/765

(52) U.S. Cl. 386/224; 386/E05.002

(57) ABSTRACT

A digitized hospital management system is provided with an in-hospital region including a first computer including a first interface and a plurality of first memory units; and a plurality of first video recording devices; an out-of-hospital region including a second computer including a second interface and a plurality of second memory units; a plurality of second video recording devices; and a plurality of auxiliary memory units; two communication devices disposed in the in-hospital region and the out-of-hospital region respectively so that the in-hospital region communicates with the out-of-hospital region or vice versa via the communication devices; and a hospital computer in data communication with the second computer. A smartphone, a laptop computer, a portable communicating device, a cloud computing device, or a data storage device is capable of communicating with the second computer.

### BACKGROUND OF THE INVENTION

1. Field of the Invention

The invention relates to hospital management and more particularly to a digitized hospital management system.

2. Description of Related Art

A conventional imaging system for managing image data generated at functionally diverse units under the direction of attending physicians associated with respective dispersed facilities in a hospital, comprising an image diagnostic system including the plural functionally diverse units, each for providing medical image data based on a signal derived from a patient; a first filing system comprising a first picture filing unit for storage of the medical image data and a first retrieval unit for retrieving data from the first picture filing unit; a second filing system comprising a second picture filing unit for storage of the medical image data and a second retrieval unit for retrieving data from the second picture filing unit; first network means comprising an optical fiber for transmitting the medical image data of the patient from the plural functionally diverse units of the image diagnostic system to the first and second filing systems, and from first picture filing unit to the first retrieval means and from the second picture filing unit to the second retrieval unit, at a first data transfer rate; second network means comprising a coaxial cable for interconnecting the first filing system and the second filing system, and for transmitting medical image data between the first filing system and the second filing system at a second data transfer rate, the first data transfer rate being greater than the second data transfer rate; recognizing means for recognizing a facility to which image data derived from a diagnosed patient is associated; transmission control means for transmitting via the first network the image data derived from the diagnosed patient from the functionally diverse units of the image data generating section where the image data was generated to the first and second filing systems recognized by the recognizing means as being associated with the image data of the diagnosed patient.

Notwithstanding the prior art, the invention is neither taught nor rendered obvious thereby.

### SUMMARY OF THE INVENTION

It is therefore one object of the invention to provide a digitized hospital management system comprising an in-hospital region comprising a first computer including a first interface and a plurality of first memory units; and a plurality of first video recording devices; an out-of-hospital region comprising a second computer including a second interface and a plurality of second memory units; a plurality of second video recording devices; and a plurality of auxiliary memory units; two communication devices disposed in the in-hospital region and the out-of-hospital region respectively so that the in-hospital region communicates with the out-of-hospital region or vice versa via the communication devices; and a hospital computer in data communication with the second computer; wherein a smartphone, a laptop computer, a portable communicating device, a cloud computing device, or a data storage device is capable of communicating with the second computer; wherein data including audio/video (AV) data recorded by the first video recording devices is stored in the first memory units; wherein the data stored in the first memory units are further stored in the second memory units; and wherein the data stored in the second memory units are further stored in the auxiliary memory units.

The above and other objects, features and advantages of the invention will become apparent from the following detailed description taken with the accompanying drawings.

### BRIEF DESCRIPTION OF THE DRAWINGS

FIG. 1 schematically depicts a digitized hospital management system according to the invention;

FIGS. 2, 3 and 4 schematically depict different portions of the system respectively;

FIG. 5 depicts interaction between the system and other devices; and

FIG. 6 is a block diagram of the system implemented in a hospital.

### DETAILED DESCRIPTION OF THE INVENTION

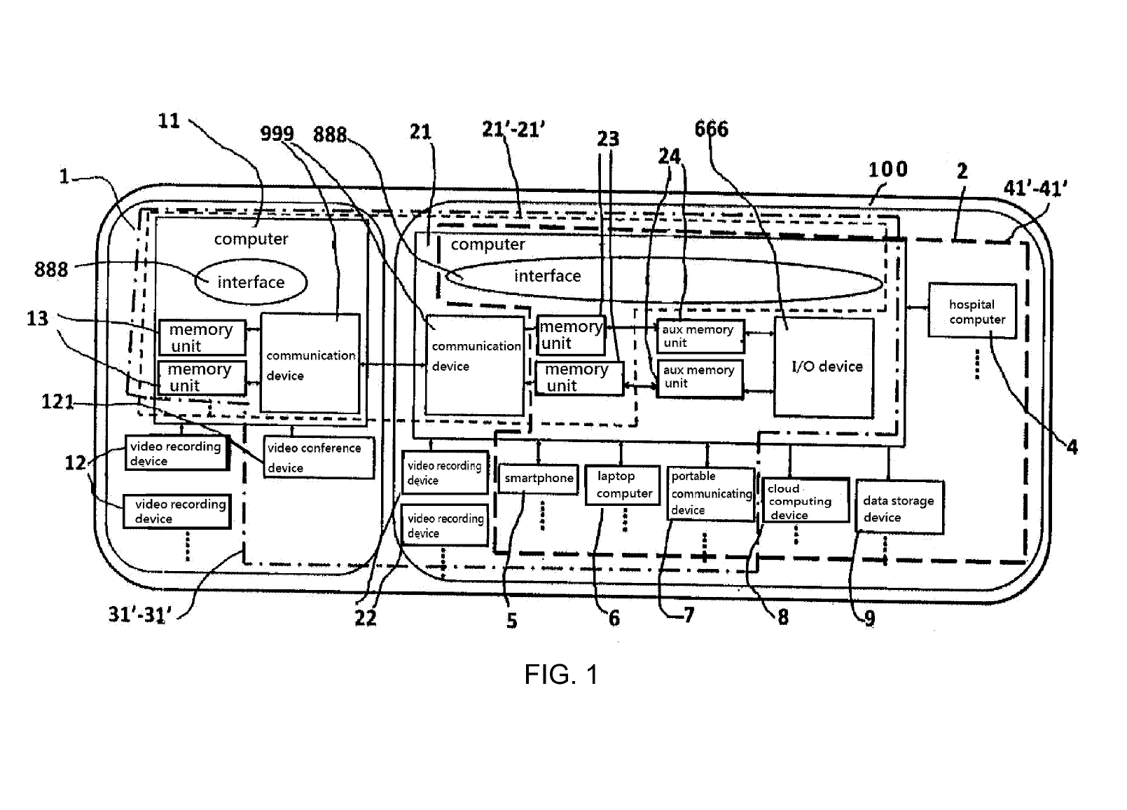

Referring to FIGS. 1 to 6, a digitized hospital management system 100 in accordance with the invention comprises the following components as discussed in detail below.

As shown in FIG. 1, an in-hospital region 1 comprises a computer 11 including an interface 888 and a plurality of memory units 13; and a plurality of video recording devices 12. An out-of-hospital region 2 comprises a computer 21 including an interface 888 and a plurality of memory units 23; a plurality of video recording devices 22; and a plurality of auxiliary memory units 24. A communication device 999 is provided in each of the in-hospital region 1 and out-of-hospital region 2 so that the in-hospital region 1 can communicate with the out-of-hospital region 2 or vice versa via the communication devices 999. The computer 21 of the out-of-hospital region 2 can send data to at least one of a hospital computer 4, a smartphone 5, a laptop computer 6, a portable communicating device 7 having audio/video transmission function, a cloud computing device 8, and a data storage device 9 via an I/O device 666. The interface 888 is implemented as a touch panel, mouse, keyboard, or radio frequency-based remote control which is capable of sending data to the computers 11, 21. The auxiliary memory unit 24 is for storing data about patients and patients' relatives.

The video recording devices 12 are connected to the computer 11 and each video recording device 12 includes a video conference device 121 for communicating a patient's relative with a hospital employee. Likewise, the video recording devices 22 are connected to the computer 21 and a hospital employee is capable of communicating with a patient's relative via the video recording device 22 and a smartphone 5 or laptop computer 6 held by the patient's relative (i.e., similar to video conference).

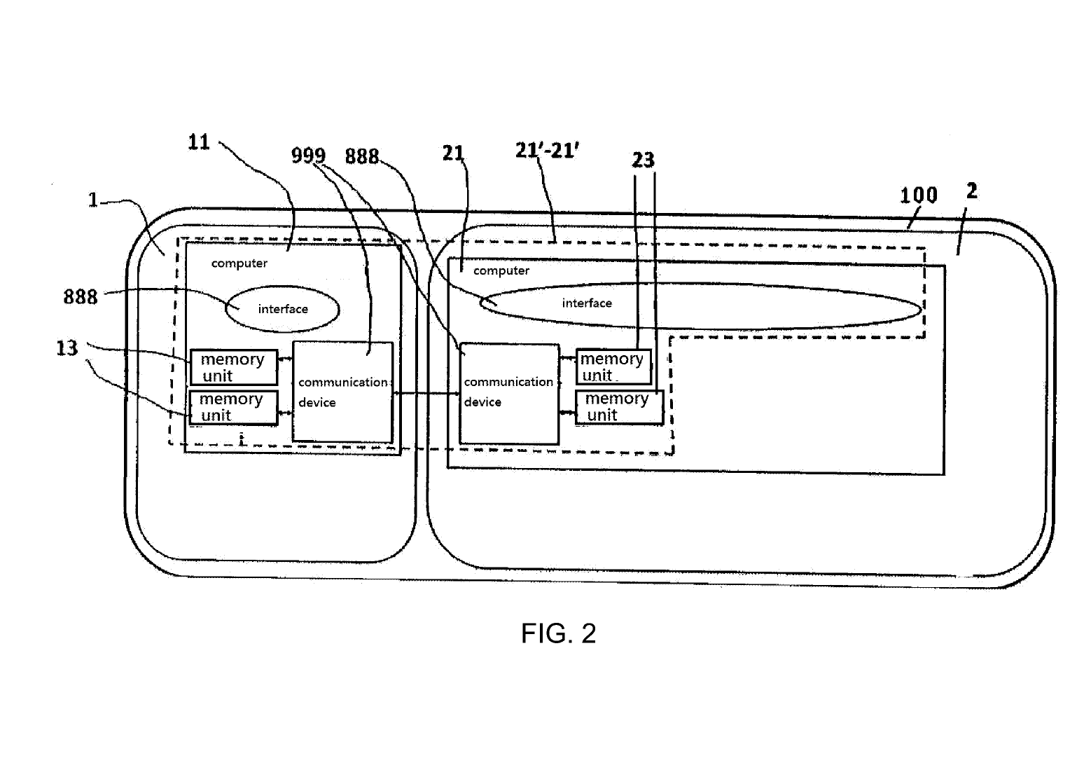

As shown in FIG. 2 specifically, it is an area bounded by broken lines 21′-21′ of FIG. 1. The communication device 999 is implemented by incorporating a PCIe (PCI Express) and has a plurality of serial channels each capable of sending 8 Gbps. Alternatively, VL-Bus (VESA Local Bus), USB (Universal Serial Bus) 2.0, IEEE1394, SATA, DDR2, or HDMI is incorporated in the communication device 999. Still alternatively, IEEE502.11, infrared, or Bluetooth® is incorporated in the communication device 999.

The computer 11 is served to store data including audio and video data in the memory units 13. Further, data stored in the memory units 13 can be sent to the memory units 23 via the communication devices 999.

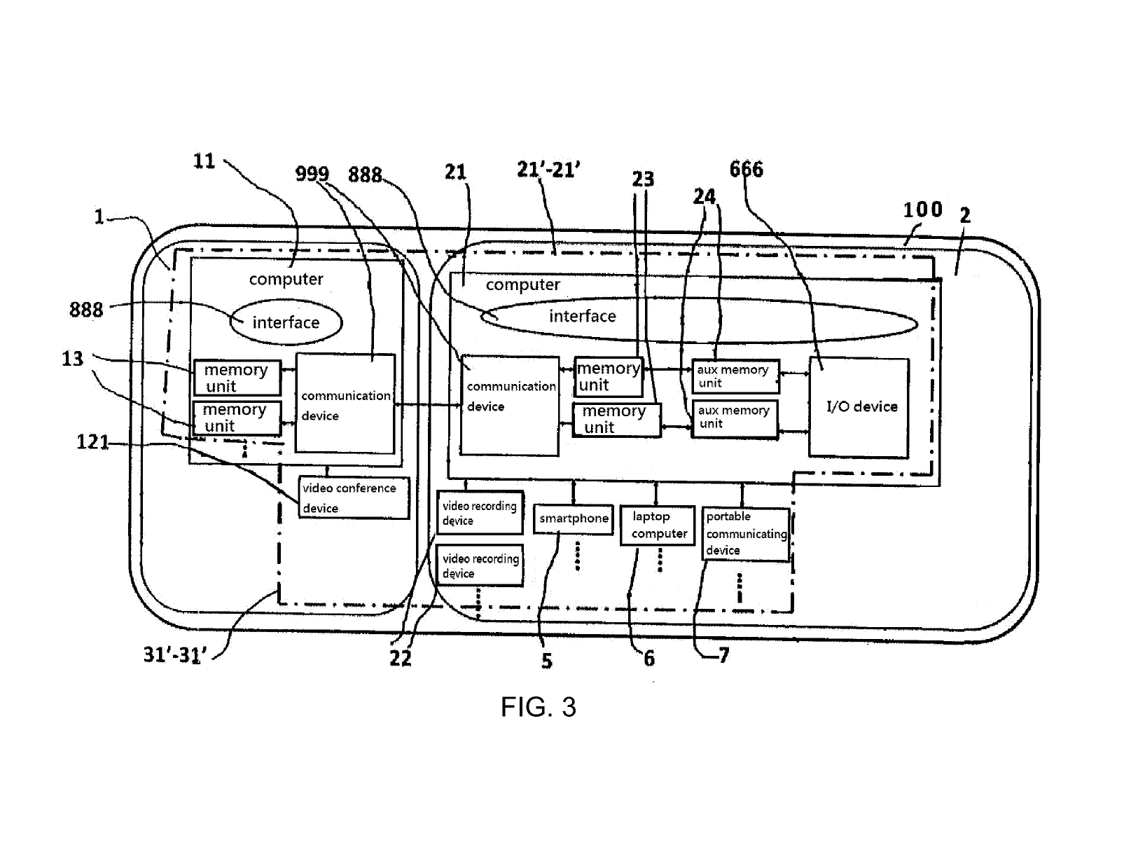

As shown in FIG. 3 specifically, it is an area bounded by broken lines 31′-31′ of FIG. 1. In case of emergency, a hospital employee (e.g., physician or nurse) can use the video conference device 121 to communicate with a patient's relative. Alternatively, a hospital employee can communicate with a patient's relative via the video recording device 22 and a smartphone 5 or laptop computer 6 held by the patient's relative.

The I/O device 666 is implemented the same as the communication device 999. Moreover, the computer 21 is served to store data including audio and video data in the memory units 23. Further, data stored in the memory units 23 can be sent to the auxiliary memory units 24 as backup.

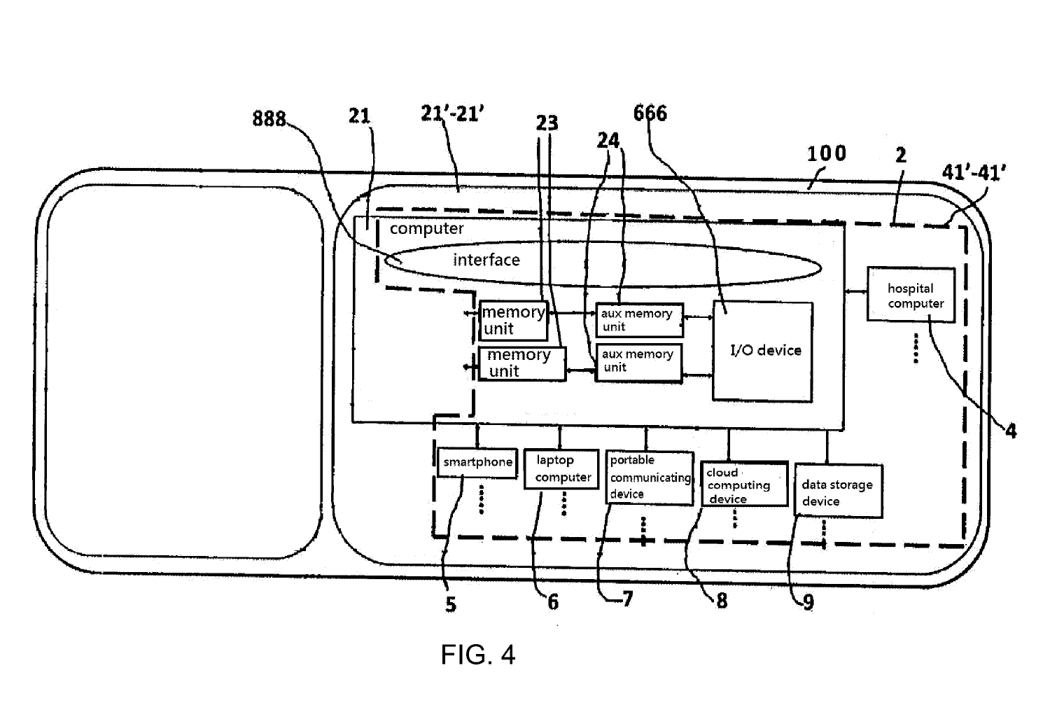

As shown in FIG. 4 specifically, it is an area bounded by broken lines 41′-41′ of FIG. 1. After seeing a physician, data including AV data is stored in the memory units 13, 23 and the auxiliary memory units 24 as a medical record. A hospital employee may use a hospital computer 4 to access the data from one of the memory units 13, 23 and auxiliary memory units 24. Also, a patient may his/her medical records using a smartphone 5, a laptop computer 6, or the data storage device 9 via the I/O device 666. Moreover, the medical records can be stored in a cloud computing device 8 via the Internet.

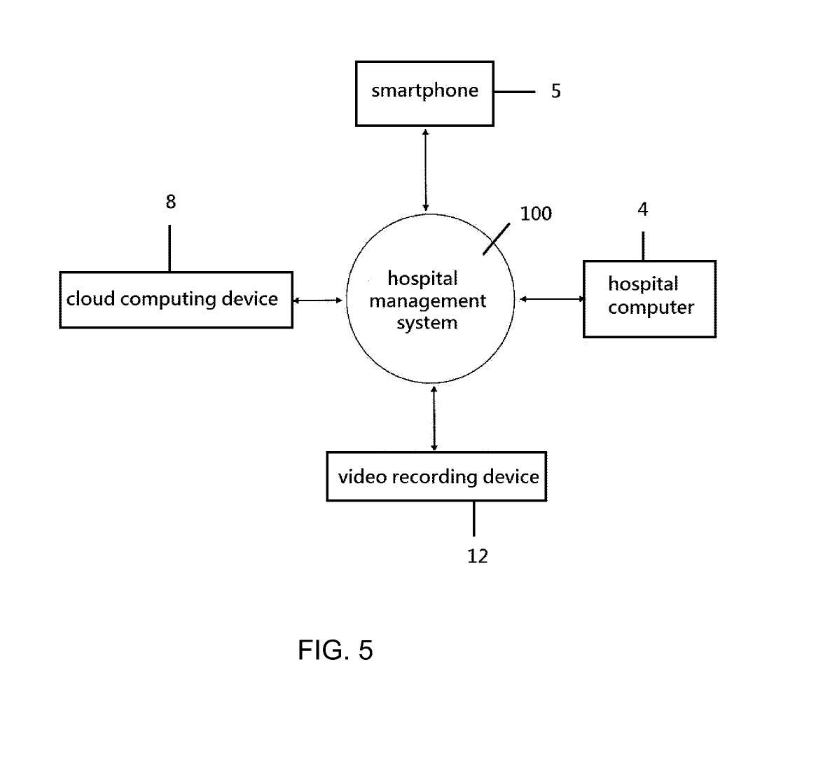

As shown in FIG. 5, the digitized hospital management system 100 can be shown in a block diagram in which the digitized hospital management system 100 may communicate with each of the smartphone 5 (or the laptop computer 6), the hospital computer 4, the cloud computing device 8, and the video recording devices 12 or 22 or vice versa in both directions simultaneously.

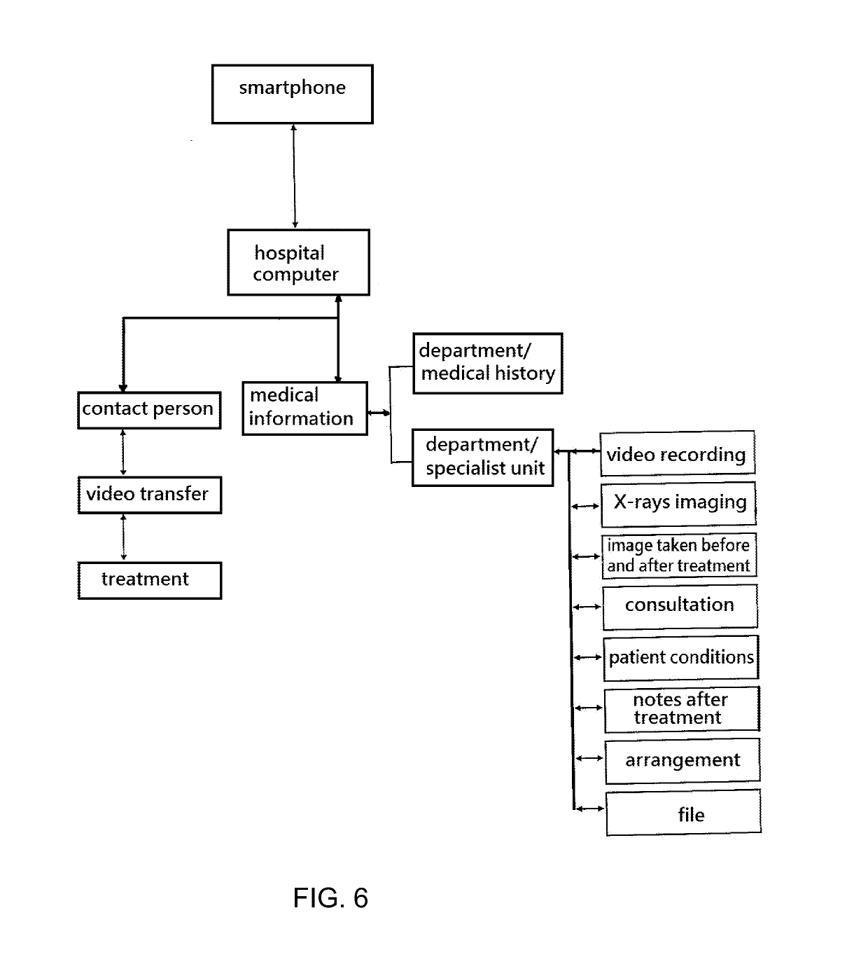

As shown in FIG. 6, the digitized hospital management system 100 can be implemented in detail as follows:

A patient carrying a smartphone or laptop computer may go to a hospital for diagnosis, etc. The patient is required to register and a hospital employee may access medical records (if any) of the patient. The medical records may have information such as contact person in case of emergency and medical history. Any treatment or therapy performed can be sent to the contact person in form of AV data. Medical information can be sent to the hospital computer 4 in duplex or sent to a relevant department or specialist unit of the hospital also in duplex. Video recording, X-rays/ultrasonic imaging, images taken before and after treatment, consultation with physician, body conditions of a patient, what a patient should note after treatment, arranging a next meeting if required, and put the medical records on file are also performed at a specific department or specialist unit in duplex.

While the invention has been described in terms of preferred embodiments, those skilled in the art will recognize that the invention can be practiced with modifications within the spirit and scope of the appended claims.

What is claimed is:

1. A digitized hospital management system comprising:
an in-hospital region comprising a first computer including a first interface and a plurality of first memory units; and a plurality of first video recording devices;
an out-of-hospital region comprising a second computer including a second interface and a plurality of second memory units; a plurality of second video recording devices; and a plurality of auxiliary memory units;
two communication devices disposed in the in-hospital region and the out-of-hospital region respectively so that the in-hospital region communicates with the out-of-hospital region or vice versa via the communication devices; and
a hospital computer in data communication with the second computer;
wherein a smartphone, a laptop computer, a portable communicating device, a cloud computing device, or a data storage device is capable of communicating with the second computer;
wherein data including audio/video (AV) data recorded by the first video recording devices is stored in the first memory units;
wherein the data stored in the first memory units are further stored in the second memory units; and
wherein the data stored in the second memory units are further stored in the auxiliary memory units.

2. The digitized hospital management system of claim 1, wherein the first video recording devices are connected to the first computer and each of the first video recording devices includes a video conference device.

3. The digitized hospital management system of claim 1, wherein the second video recording devices are connected to the first computer and each of the second video recording devices includes a video conference device.

4. The digitized hospital management system of claim 3, wherein each of the communication devices incorporates one of PCIe (PCI Express), VL-Bus (VESA Local Bus), USB 2.0, IEEE1394, SATA, DDR2, and HDMI.

5. The digitized hospital management system of claim 4, wherein the in-hospital region further comprise a second computer including a second interface and a plurality of second memory units; and a plurality of second video recording devices; and the out-of-hospital region further comprises a third computer including a third interface and a plurality of third memory units; a plurality of third video recording devices; and a plurality of first auxiliary memory units.

6. The digitized hospital management system of claim 1, wherein the data storage operation is done either sequentially in the order of storage and recordation or simultaneously.

7. The digitized hospital management system of claim 1, wherein the interface is a point of communications between the computers and a computer display.

8. The digitized hospital management system of claim 1, wherein an individual may use a smartphone, a laptop computer, a portable communicating device, a cloud computing device, or a data storage device to communicate with each computer for accessing data stored in each of the memory units.

9. The digitized hospital management system of claim 8, wherein an individual may use a smartphone, a laptop computer, a portable communicating device, a cloud computing device, or a data storage device to communicate with each computer for accessing data stored in each of the memory units, the data including medical history.

10. The digitized hospital management system of claim 1, wherein the number of the interfaces is more than one and the number of the I/O devices is more than one.

11. The digitized hospital management system of claim 9, wherein a confirmation procedure is performed when a patient registers in the counter.

12. The digitized hospital management system of claim 10, wherein a medical employee may use an AV device to record what is being done in an operation room and the recorded AV clips can be sent to the patient upon request.
